(19) United States
(12) Patent Application Publication
(10) Pub. No.: US 2023/0159061 A1
(43) Pub. Date: May 25, 2023

(54) METHOD FOR CLEARING PASSAGE

(71) Applicant: MERCEDES-BENZ GROUP AG, Stuttgart (DE)

(72) Inventor: Axel FRITZ, Boll (DE)

(21) Appl. No.: 17/920,432

(22) PCT Filed: Mar. 2, 2021
(86) PCT No.: PCT/EP2021/055156

§ 371 Date: Oct. 21, 2022

(30) Foreign Application Priority Data
Apr. 24, 2020 (DE) 10 2020 111 178.9

(51) Int. Cl. B60W 60/00; B60W 40/06

(52) U.S. Cl. CPC B60W 60/0059; B60W 40/06; B60W 2552/53; B60W 2556/45

(57) ABSTRACT

A method for clearing passage of a tunnel in the automated driving mode of a vehicle involves checking, in a manual driving mode with passive automated driving mode of the vehicle, whether the tunnel is suitable for passage in the automated driving mode of the vehicle. During the check control commands for actuators of a longitudinal and transverse movement of the vehicle are generated, but are not implemented by the actuators. In the event that no unmanageable situation is detected in the tunnel during the check and the generated control commands are plausible in relation to interventions made by a vehicle user in manual driving mode with passive automated driving mode, the tunnel is assessed as suitable for automated driving mode.

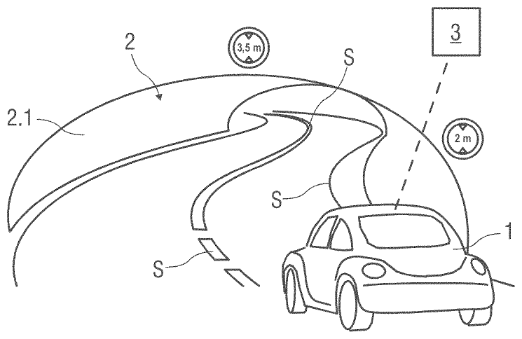

### BACKGROUND AND SUMMARY OF THE INVENTION

Exemplary embodiments of the invention relate to a method for clearing passage through a tunnel in the automated driving mode of a vehicle.

A method for autonomous operation of a vehicle on a route ahead is known from DE 10 2014 014 120 A1. The method provides that the autonomous operation of the vehicle is permitted only if one or a group of the following conditions is/are fulfilled for a predetermined route length of the route ahead: there is a structural separation on at least one side of a current lane of the vehicle; a lane of the vehicle has a minimum lane width; there are no humps or depressions significantly limiting the range of environment detection sensors; the number of lanes does not change; there is no tunnel; there is no building on the carriageway; there is no motorway intersection; a radius of curvature of the lane of the vehicle is greater than a specified limit value; there is no traffic incident; there is no traffic message regarding hazardous situations; there is no traffic message regarding the presence of roadworks.

Exemplary embodiments of the invention address the problem of specifying a method for clearing passage through a tunnel in the automated driving mode of a vehicle.

In accordance with the invention, a method for clearing passage through a tunnel in the automated driving mode of a vehicle provides that it is checked in a manual driving mode with passive automated driving mode of the vehicle whether the tunnel is suitable for passage in the automated driving mode of the vehicle. For this purpose, control commands for actuators of a longitudinal and transverse movement of the vehicle are generated during the check, but are not implemented by means of the actuators, and in the event that no unmanageable situation in the tunnel is detected during the check and the generated control commands are plausible in relation to interventions made by a vehicle user in manual driving mode with passive automated driving mode, the tunnel is assessed as suitable for automated driving mode. Otherwise, the tunnel is assessed as unsuitable for automated driving mode.

In this context, an automated driving mode means, in particular, a highly automated driving mode in which the vehicle is operated without intervention by the vehicle user. In such a highly automated driving mode, the vehicle user has completely handed over the driving task to the vehicle. However, they must be prepared to take over the driving task again if they receive a take-over request from the vehicle.

By application of the method, it is possible to determine whether the corresponding tunnel is suitable for passage in automated driving mode and thus whether conditions for automated driving mode are fulfilled. In this way, the safety during passage through the tunnel can be increased and it is possible, if the tunnel is suitable, to drive through the tunnel in automated mode.

In particular, the suitability or unsuitability of the tunnel for passage in automated driving mode is checked by multiple vehicles that have a function for automated driving mode.

In one embodiment of the method, it is determined whether the generated control commands cause the same reaction of the vehicle as the interventions made by the vehicle user, wherein it is also determined whether a possible deviation lies within the specified tolerance range. In the state of the manual driving mode with passive system for automated driving mode, algorithms for generating the control commands continue to run but are not implemented. Since the algorithms continue to run, situations that are not designed to be handled by the system for automated driving are also detected.

In a development of the method, the tunnel is assessed as not suitable for automated driving mode if a situation is detected in which a lane marking is absent and/or in which a lane marking and/or an object within the tunnel is/are not sensed with a sufficient level of quality, because the system cannot handle such a situation.

A possible development of the method provides that the suitability or unsuitability of the tunnel for automated driving mode is transmitted as information to a central computer unit connected to the vehicle. This allows the information to be evaluated and compared with information from other vehicles, and the information can thus also be made available to other vehicles.

In a further embodiment, the central computer unit statistically evaluates such transmitted information and makes an assessment in respect of suitability or unsuitability. Here, transmitted information of all vehicles that have checked the tunnel in manual driving mode with passive automated driving mode is transmitted to the central computer unit. This means that the central computer unit evaluates, in particular, whether the tunnel can be driven through in multiple vehicles in automated driving mode.

In particular, in one possible embodiment, the suitability or unsuitability of the tunnel for automated driving mode is determined based on a frequency analysis performed. The more vehicles that have checked the tunnel with regard to automated driving mode, the more valid the result with regard to suitability or unsuitability.

One variant of the method provides that the tunnel is assessed as suitable for automated driving mode if a suitability frequency exceeds an unsuitability frequency by a specified amount. The greater the specified amount, the greater the validity with regard to the suitability or unsuitability of the tunnel for automated driving mode. Accordingly, the safety when driving through the tunnel in automated driving mode can be classified as high or low.

In a further variant, vehicles connected to the central computer unit are provided with information regarding the suitability or unsuitability of the tunnel for passage in automated driving mode, so that a vehicle user can decide whether to drive through the tunnel manually or whether to drive through the tunnel in automated driving mode.

Exemplary embodiments of the invention are explained in greater detail below with reference to a drawing.

### BRIEF DESCRIPTION OF THE SOLE DRAWING

In the drawing:

The sole FIGURE schematically illustrates a vehicle entering a tunnel.

### DETAILED DESCRIPTION

The single FIGURE shows a vehicle 1 entering a tunnel 2.

The vehicle 1 has a system for automated driving mode in which the vehicle 1 fully performs a driving task thereof, wherein the vehicle 1 can also be driven in manual driving mode, in which the driving task is performed by a vehicle user.

Automated driving mode, which is also referred to as highly automated driving, is usually permitted only on portions of road that have been approved for this purpose. It is generally known that tunnels 2 have not yet been approved for automated driving mode, as can be inferred from the prior art cited at the outset.

Reasons why tunnels 2 are usually not cleared for automated driving mode are constituted by an unreliable localization of a vehicle 1 in the tunnel 2 due to a lack of connection to satellites for position determination, a danger that a required data connection of the vehicle 1 to a central computer unit 3 within the tunnel 2 will be interrupted, and/or an unreliable environment recognition due to multiple reflections of sensor signals of an environment sensor system of the vehicle 1 occurring, in particular of radar-based sensor signals, on tunnel walls 2.1 and/or due to structural conditions and/or lane markings being hardly or not at all recognizable by sensors.

In order to clear a tunnel 2 for automated driving mode of the vehicle 1, a method described hereinafter is provided. In particular, the method provides that the automated driving mode be cleared for the tunnel 2 by means of the central computer unit 3 if it has previously been confirmed by multiple vehicles 1 that the tunnel 2 is suitable for passage in automated driving mode.

A checking of the suitability of the tunnel 2 for automated driving is performed in that the vehicle 1 drives through the tunnel 2 in manual driving mode and passive automated driving mode.

In such a state of the vehicle 1, algorithms for generating control commands for actuators of a longitudinal and transverse control of the vehicle 1 continue to run, however, the control commands are not implemented in the actuators or by means of the actuators. Since the algorithms continue to run in passive automated driving mode, the system is able to detect situations that are not designed to be handled by the system for automated driving mode. For example, these are situations in which lane markings S are absent and/or in which lane markings S and/or other objects in the tunnel 2 cannot be detected by sensors with the required level of quality.

At the same time, the interventions made by the vehicle user when driving through the tunnel 2 in manual driving mode with regard to a longitudinal and transverse guidance of the vehicle 1 are recorded.

In the case that the system for automated driving mode does not detect a situation that is unmanageable when driving through the tunnel 2, and the control commands are plausible in relation to the interventions made by the vehicle user when driving through the tunnel 2 manually, then the tunnel 2 is assessed as suitable for automated driving mode.

Here, ‘plausible’ means that the control commands, if implemented, would cause substantially the same reactions as the interventions made by the vehicle user. The expression ‘substantially the same reactions’ means that any deviations lie within a specified tolerance range. In other words, the system for automated driving mode thus checks whether, in a given situation, it would act substantially in the same way as the vehicle user has just acted. The system thus learns whether it would handle the given situation substantially the same way as the vehicle user did.

If, as described above, the system detects that there is no unmanageable situation present in the tunnel 2 and the unimplemented control commands are plausible in relation to the interventions made by the vehicle user, the tunnel 2 is assessed as suitable. Otherwise, the tunnel 2 is assessed as unsuitable for automated driving mode. Information regarding suitability or unsuitability is transmitted to the central computer unit 3 after driving through the tunnel 2.

If multiple vehicles 1 transmit information regarding the suitability or unsuitability of this tunnel 2 for automated driving mode to the central computer unit 3, the latter has a sufficient database for a statistical evaluation of the suitability or unsuitability of the tunnel 2.

By means of the central computer unit 3, the information transmitted for the specific tunnel 2 is statistically evaluated and, depending on the available information, a decision is made as to whether the tunnel 2 should be cleared for automated driving mode or should remain blocked for automated driving mode.

The static evaluation may provide for a frequency analysis in which a suitability frequency detected on the basis of the information is compared with an unsuitability frequency detected on the basis of the information.

The suitability frequency is understood here to be the frequency that the central computer unit 3 has determined on the basis of information from vehicles 1 assessing the tunnel 2 as suitable for automated driving mode. Accordingly, the unsuitability frequency is understood to be the frequency that the central computer unit 3 has determined on the basis of information from vehicles 1 assessing the tunnel 2 as unsuitable for automated driving mode.

In one possible embodiment, the tunnel 2 is cleared for automated driving mode by means of the central computer unit 3 if the suitability frequency exceeds the non-suitability frequency by a specified amount. If this is not the case, the tunnel 2 remains blocked for the automated driving mode of vehicles 1.

For example, vehicles 1 connected to the central computer unit 3 are provided with information regarding the suitability or unsuitability of the tunnel for passage in automated driving mode, so that the vehicle user in question can decide for themself in which driving mode of the vehicle 1 they will drive through the tunnel 2.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-8. (canceled)

9. A method for clearing passage through a tunnel in an automated driving mode of a vehicle, the method comprising:
checking, in a manual driving mode with a passive automated driving mode of the vehicle, whether the tunnel is suitable for passage in the automated driving mode of the vehicle, wherein, during the checking, control commands for actuators of longitudinal and transverse movement of the vehicle are generated but are not implemented by the actuators, and
determining that the tunnel is suitable for automated driving mode when there is no unmanageable situation detected in the tunnel during the check and the generated control commands are plausible in relation to interventions made by a vehicle user in the manual driving mode with the passive automated driving mode.

10. The method of claim 9, further comprising:
determining whether the generated control commands cause a same reaction of the vehicle as the interventions made by the vehicle user; and
determining whether a possible deviation between the generated commands and the interventions made by the vehicle user lies within a predetermined tolerance range.

11. The method of claim 9, further comprising:
determining that the tunnel is unsuitable for the automated driving mode when a situation is detected in which a lane marking is absent, a lane marking within the tunnel is not sensed with a sufficient level of quality, or an object within the tunnel is not sensed with a sufficient level of quality.

12. The method of claim 11, further comprising:
transmitting, by the vehicle to a central computer unit, the determination that the tunnel is suitable or is unsuitable for the automated driving mode.

13. The method of claim 12, wherein the central computer unit statistically evaluates and determines the suitability or unsuitability of the tunnel for the automated driving mode based on the transmitted determination.

14. The method of claim 13, wherein the statistical evaluation involves a frequency analysis.

15. The method of claim 12, wherein the central computer unit determines that the tunnel is suitable for the automated driving mode if a suitability frequency exceeds an unsuitability frequency by a specified amount.

16. The method of claim 12, wherein the central computer provides information regarding the suitability or the unsuitability of the tunnel for passage in the automated driving mode to other vehicles.
